(19) United States
(12) Patent Application Publication
(10) Pub. No.: US 2009/0035087 A1
(43) Pub. Date: Feb. 5, 2009

(54) MACHINE TOOL

(76) Inventors: Kazuo Nakamoto, Kanagawa (JP); Shinichi Matsumoto, Fukui (JP)

Correspondence Address: MCDERMOTT WILL & EMERY LLP, 18191 VON KARMAN AVE., SUITE 500, IRVINE, CA, 92612-7108, US

(21) Appl. No.: 11/995,819

(22) PCT Filed: Sep. 11, 2006
(86) PCT No.: PCT/JP2006/318445

§ 371 Date: Jan. 15, 2008

(30) Foreign Application Priority Data
Sep. 9, 2005 (JP) 2005-263006

(51) Int. Cl. B23C 1/14

(52) U.S. Cl. 409/165

(57) ABSTRACT

A machine tool comprises a shrink fit holder fixed to a lower end of a rotatable spindle, and a high frequency induction heating unit configured to heat the shrink fit holder by high frequency induction. The high frequency induction heating unit is configured to move between a retracted position and the shrink fit holder by a Z axis carriage and a V axis carriage. The retracted position is a position where the high frequency induction heating unit is separated from the shrink fit holder to such an extent that there is no obstruction to machining. A cooling unit is provided on the high frequency induction heating unit, the cooling unit being configured to supply compressed air for cooling the shrink fit holder. A supply pot and a collection pot are provided side by side and are configured to respectively hold a tool. These pots are configured to move between their retracted positions and the shrink fit holder.

### CROSS-REFERENCE TO RELATED APPLICATION

This application is a National Stage application of International Application No. PCT/JP2006/318445, with an international filing date of Sep. 11, 2006.

### TECHNICAL FIELD

The present invention relates to a machine tool provided with an automatic tool changer. In particular, the present invention relates to a machine tool that can exchange tools using a shrink fit holder.

### BACKGROUND OF THE INVENTION

Generally, a plurality of tool holders with tools attached are stored in a magazine, and an automatic tool changer (ATC) for a machine tool selectively conveys a tool holder in the magazine to a spindle head and automatically fits the tool holder to a rotating spindle. In many cases, a tapered socket into which a tapered shank of the tool holder is fitted is formed in a lower end of the spindle. The spindle head has a collet chuck for grasping a knob of a tool holder tapered shank, and a draw bar for drawing the collet chuck upward into the spindle. In recent years, tool holders are increasingly being used that hold a tool by shrink fitting (“shrink fit holder”). A shrink fit holder includes at least partially a cylindrical section or ring that is made from a material having a larger thermal expansion coefficient than the tool, for example, stainless steel or austenitic steel. The cylindrical section has a central hole or recess into which the shank of a tool is fitted. The diameter of the central hole is normally slightly smaller than the shank of the tool. If the central hole of the cylindrical section is expanded by heating, the shank of the tool can then be easily inserted into the central hole. If the cylindrical section then contracts due to cooling, the shrink fit holder and the tool can be rigidly joined.

Japanese patent laid-open No. 2003-025158 discloses a shrink fit unit using high frequency induction heating. The disclosed unit can locally heat a shrink fit holder, and can bring about a state where a tool can be fitted into a shrink fit holder with a few seconds of heating. This reference also indicates that attaching a tool rigidly and accurately in the shrink fit holder gives excellent dynamic balance in a high speed rotation region.

Japanese patent laid open No. 2005-118888 discloses a machine tool capable of automatically supplying a tool to a magazine while attaching the tool to a shrink fit holder. This machine tool is stated to do away with the labor time for an operator to attach the tool to the shrink fit holder, and at the same time can significantly shorten the total time required for tool change. However, this machine tool has limits with respect to accuracy and rigidity of attaching the shrink fit holder to a spindle, and there may be a need for improvement with respect to machining accuracy and high speed rotation capability.

Japanese patent laid-open No. 2000-343306 discloses a spindle unit for direct attachment of a tool to a spindle using shrink fitting. This spindle unit can shorten the setup time when the shrink fit holder is not required. It also can rigidly attach a tool to the spindle with good precision. However, since this spindle is repeatedly subjected to direct heating and cooling, there is a danger of the spindle suffering heat deformation to an extent it cannot be restored, and spindle lifespan being shortened.

U.S. Pat. No. 5,140,739 discloses a clamp unit with a male holder having a low thermal expansion coefficient fixed to a lower end of a spindle, for attaching a female holder, to which a tool is attached, to the male holder by shrink fitting. A rapid heating unit and a rapid cooling unit for the female holder are provided in the clamp unit. According to this clamp unit, it is possible to shorten the heating and cooling time, and also rigidly and accurately attach a tool holder to the spindle. However, a preparatory operation is typically necessary to attach the tool to the tool holder in advance.

### DISCLOSURE OF THE INVENTION

An object of the present invention is to provide a machine tool capable of exchanging a tool, where connection between a shrink fit holder and a spindle is strong.

Another object of the present invention is to provide a machine tool capable of exchanging a tool, where the effect of heating on the spindle is smaller.

Yet another object of the present invention is to provide a machine tool capable of exchanging a tool, having a compact spindle head.

According to one aspect of the present invention, a machine tool comprises a rotatable spindle, a shrink fit holder fixed to a lower end of the spindle, and a high frequency induction heating unit configured to heat the shrink fit holder by high frequency induction. The high frequency induction heating unit is configured to move between the shrink fit holder and a retracted position separated from the shrink fit holder.

The retracted position can be a position where the high frequency induction heating unit is separated from the shrink fit holder to such an extent that there is no obstruction to machining.

The machine tool may further comprise a Z axis carriage configured to move the high frequency induction heating unit vertically, and a V axis carriage configured to move the high frequency induction heating unit horizontally.

The high frequency induction heating unit may include a heating coil, and a high frequency power supply configured to supply high frequency power to the heating coil. Further, the heating coil may have a ring configured to surround the shrink fit holder.

The machine tool may comprise a cooling unit configured to cool the shrink fit holder, provided in the high frequency induction heating unit. The cooling unit may be configured to supply compressed air to the shrink fit holder.

According to another aspect of the present invention, a machine tool comprises a rotatable spindle, a shrink fit holder fixed to a lower end of the spindle, and a pair of pots configured to respectively hold a tool. The pair of pots are provided side by side, and are configured to move between the shrink fit holder and a retracted position separated from the shrink fit holder.

The retracted position can be a position where the pair of pots are separated from the shrink fit holder to such an extent that there is no obstruction to machining.

The machine tool may comprise a Z axis carriage configured to move the pair of pots vertically, and a V axis carriage configured to move the pair of pots horizontally.

The machine tool may comprise a tool magazine configured to store tools and a damper configured to grasp a tool, and the damper is configured to move between the tool magazine and the retracted position.

Preferably, the machine tool further comprises a raising and lowering unit configured to move the damper vertically, and a U axis carriage configured to move the damper horizontally.

According to another aspect of the invention, a machine tool comprises a rotatable spindle, a shrink fit holder, having a central hole into which a tool can be inserted from below, fixed to a lower end of the spindle, a supply pot configured to hold the tool so as to project upward by a projection length, and a measuring unit configured to measure the projection length. The supply pot is configured to move between the shrink fit holder and a retracted position separated from the shrink fit holder.

According to yet another aspect of the present invention, a machine tool comprises a rotatable spindle having an axial hole passing therethrough, a shrink fit holder fixed to a lower end of the spindle, and a suction unit configured to suction air inside the axial hole. The shrink fit holder has a central hole communicating with the axial hole, and a tool may simply be inserted into the central hole using the suction unit.

The suction unit may be configured to discharge air into the axial hole to remove the tool from the shrink fit holder.

The machine tool contains a center pin configured to lower inside the central hole through the axial hole. The center pin may be attached to a lower end of a piston configured to reciprocate vertically.

Other objects, advantages and novel features will be partially described in the explanation which follows, and will be apparent to practitioners of the art through implementation of the invention.

### BRIEF DESCRIPTION OF THE DRAWINGS

FIG. 1 is a perspective view showing a machine tool of the present invention.

FIG. 2 is a perspective view showing an automatic tool changer of FIG. 1.

FIG. 3 is a cross sectional drawing showing a spindle head of FIG. 1 with a tool not attached.

FIG. 4 is a cross sectional drawing showing a spindle head of FIG. 1 with a tool attached.

FIG. 5 is a side view showing a supply pot in FIG. 2.

### DETAILED DESCRIPTION OF THE PREFERRED EMBODIMENTS

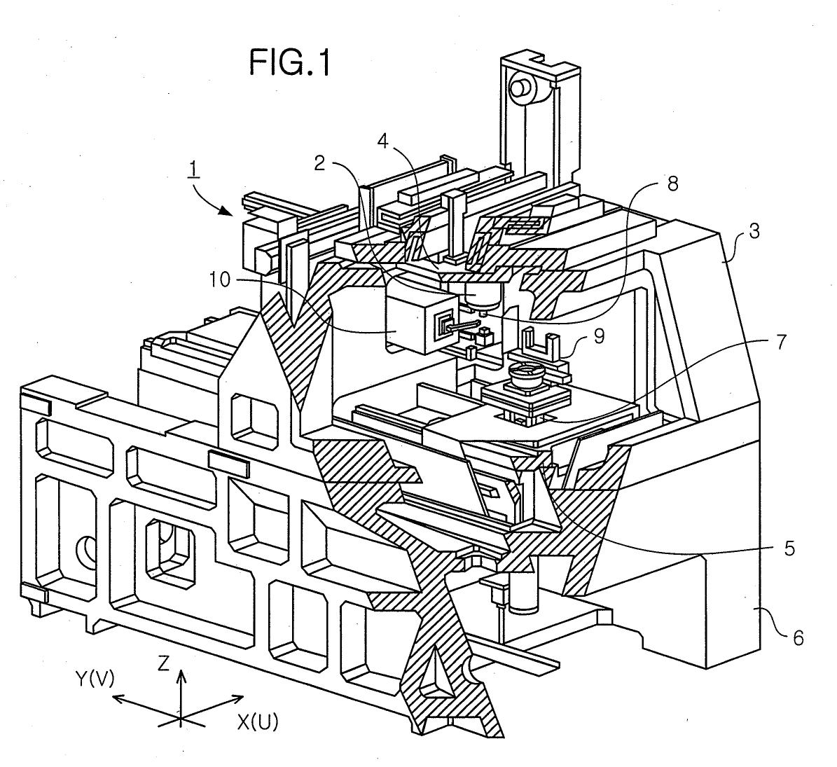

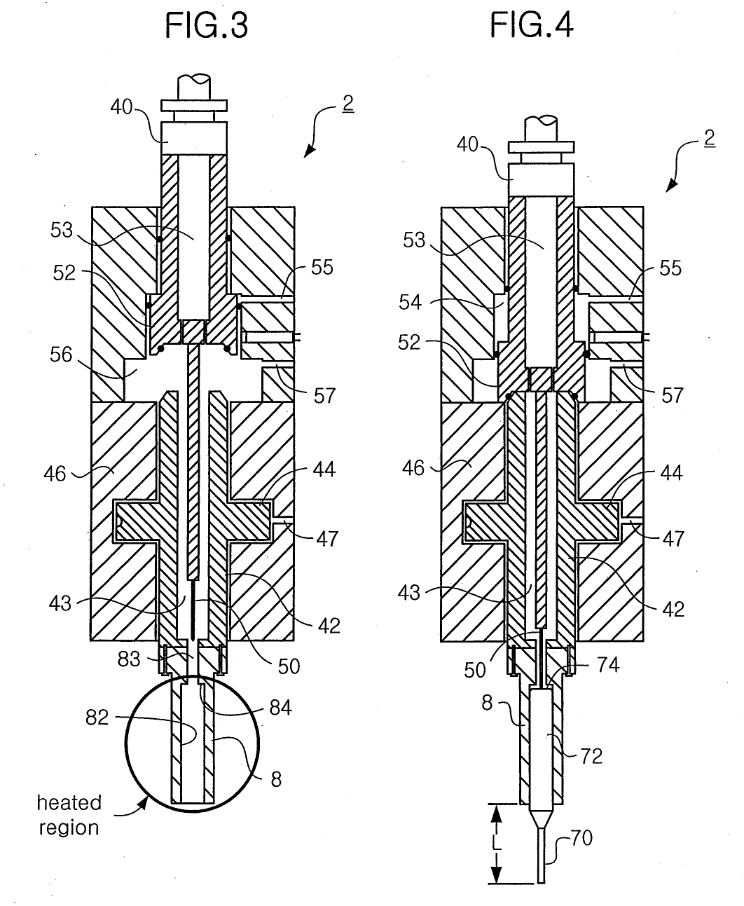

A machine tool of the present invention will now be described in detail in the following with reference to FIGS. 1 to 5. The machine tool shown in FIG. 1 is a cutting machine tool capable of moving a tool such as an end mill simultaneously in three axis directions, namely X, Y and Z axis directions, relative to a workpiece. An automatic tool changer 1 is provided on the machine tool. A slider 4 is provided on an upper part of a stationary beam 3, capable of moving in the X axis direction. A spindle head 2 having a rotatable spindle 42 (see, e.g., FIG. 3) is fixed to the bottom of the slider 4. A table 5 is provided on the bed 6 movable in the Y axis direction. Another slider 7 for reciprocally moving the workpiece in the Z axis direction is fixed to the table 5. The slider 4 typically only moves in the X axis direction, so vibration of the spindle head 2 is small. As a result, the machine tool has the advantage that straightness of the rotational center of the spindle 42 is maintained with high precision.

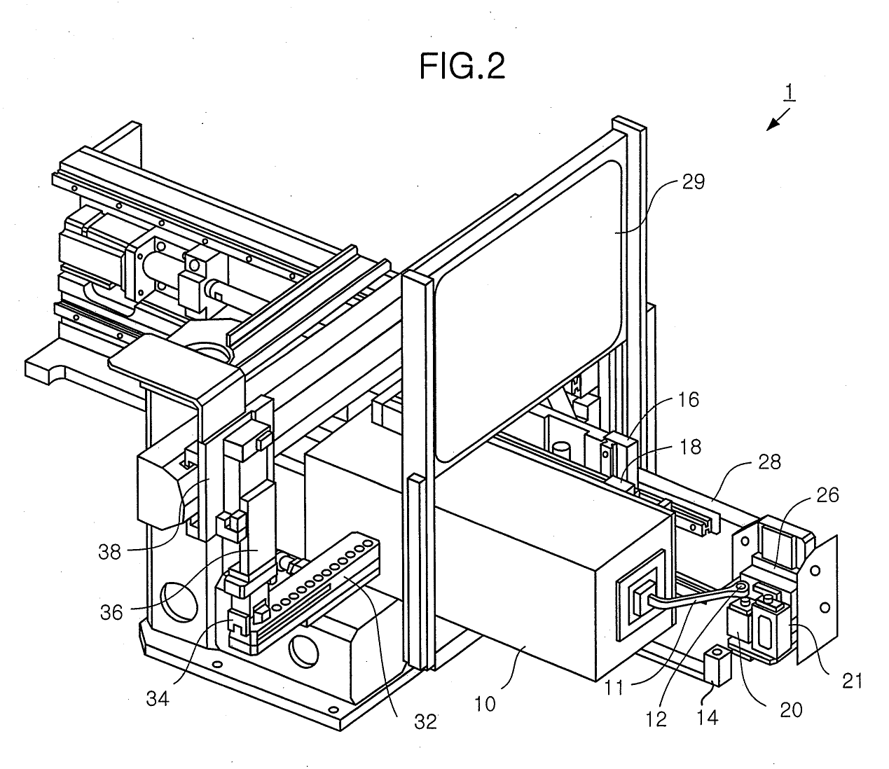

As shown in FIG. 2, the automatic tool changer 1 contains a pair of pots for holding the tool 70 (see, e.g., FIG. 4), namely a supply pot 20 and a collection pot 21. The supply pot 20 and the collection pot 21 are provided side by side on a Z axis carriage 26. The Z axis carriage 26 is provided on a V axis carriage 28 so as to vertically reciprocate. The V axis carriage 28 is capable of reciprocating movement in the horizontal V axis direction. The supply pot 20 and the collection pot 21 can be moved between a retracted position and a shrink fit holder 8 by the Z axis carriage 26 and the V axis carriage 28. The retracted position is a position where the pair of pots 20 and 21 are separated from the shrink fit holder 8 to such an extent that there is no obstruction to machining. The automatic tool changer 1 includes a rack type tool magazine 32 and a damper 34 for grasping a tool. The tool magazine 32 stores a plurality of tools 70. The damper 34 is provided on a raising and lowering unit 36 that is capable of moving in the vertical direction. The raising and lowering unit 36 is provided on the U axis carriage 38. The U axis carriage 38 can move in the U axis direction orthogonal to the V axis in a horizontal plane. The damper 34 is capable of movement between the tool magazine 32 and a retracted position, using the raising and lowering unit 36 and the U axis carriage 38. The damper 34 selectively takes a tool 70 from the tool magazine 32, and delivers the tool 70 to the supply pot 20 at the retracted position. The supply pot 20 conveys the tool 70 from the retracted position to the shrink fit holder 8. The collection pot 21 conveys the tool 70 from the shrink fit holder 8 to the retracted position. The damper 34 receives a tool 70 from the collection pot 21 at the retracted position, and returns the tool 70 to the tool magazine 32. It is possible for one pot to serve as both the supply pot 20 and the supply pot 21. However, by providing two pots it is possible to carry out removal and mounting of the tool 70 consecutively without moving a collection pot to the retracted position. Accordingly, the automatic tool changer 1 has the advantage that time for tool change is made shorter.

The automatic tool changer 1 further includes a high frequency induction heating unit 10 and a cooling unit 14, and these two units can be moved between a retracted position and the shrink fit holder 8. The high frequency induction heating unit 10 locally heats the shrink fit holder 8, which is typically made of stainless steel or Austenitic steel. The cooling unit 14 is provided on the high frequency induction heating unit 10, and supplies compressed air for cooling the shrink fit holder 8. The high frequency induction heating unit 10 includes a heating coil 11 and a high frequency power supply. The heating coil 11 has, at its tip end, a ring 12 that can surround the shrink fit holder 8. The high frequency power supply is provided with an oscillator 24, capable of supplying high frequency current of 1 MHz-3 MHz to the heating coil 11. While it is dependent on the material and size of the shrink fit holder, a shrink fit holder 8 for a tool shank of φ 2 mm-5 mm requires a high frequency current of 1.8 MHz or more. With a current of a frequency of 1.2 MHz or less there is a possibility that the shrink fit holder 8 will not undergo sufficient thermal expansion. The heating time for the high frequency induction heating unit 10 to cause sufficient thermal expansion of the shrink fit holder 8 is only a few seconds. Accordingly, other members inside the spindle head 2 are not affected by heat. Also, because the heating time is short, the temperature of the shrink fit holder 8 does not become excessively high. There is therefore the advantage that since cooling time is also short it is possible to shorten the time required to change a tool. The high frequency induction heating unit 10 is provided on a V axis carriage 18 capable of moving in the V axis direction. The V axis carriage 18 is provided on a Z axis carriage 16 capable of reciprocating movement in a vertical direction. The high frequency induction heating unit 10 and the cooling unit 14 can be moved between their retracted positions and the shrink fit holder 8 by the V axis carriage 18 and the Z axis carriage 16. The retracted positions are positions where the high frequency induction heating unit 10 and the cooling unit 14 are separated from the shrink fit holder 8 to such an extent that there is no obstruction to machining. When the shrink fit holder 8 is heated, the high frequency induction heating unit 10 is moved in accordance with a specified control sequence to a position where the heating coil 11 can heat the shrink fit holder 8. Similarly, when cooling the shrink fit holder 8, the cooling unit 14 is moved to a position where it can cool the shrink fit holder 8.

As shown in FIG. 3 and FIG. 4, the spindle head 2 is an air spindle unit having a spindle 42. The spindle 42 has an axial hole 43 passing through it, and is housed inside a housing 46. A turbine 44 is integrally formed with the spindle 42. An air gap of about 10 μm is formed between the turbine 44 and the housing 46. An introduction port 47 is formed in the housing 46. By introducing compressed air from the introduction port 47 to cause the turbine 44 to rotate, it is possible to rotate the spindle 42. The spindle 42 is preferably made of a lightweight material. The shrink fit holder 8 is coaxially fixed to a lower end of the spindle 42. A heat insulating material is preferably provided between the shrink fit holder 8 and the spindle 42. The shrink fit holder 8 has a center hole 82 into which a shank 72 of a tool 70 can be fitted from underneath. As shown in FIG. 3, a communicating hole 83 extending upwards from the bottom surface 84 of the center hole 82 is formed. The communicating hole 83 makes the center hole 82 communicate with the axial hole 43. A shrink fit holder 8 that can no longer be used is removed from the spindle 42 and replaced with a new shrink fit holder 8. A piston 52 is provided above the spindle 42. An upper part of the housing 46 functions as a cylinder in which the piston 52 slides. A front chamber 54 and a rear chamber 56 are formed in the housing 46. Ports 55 and 57 for guiding compressed air are formed in the housing 46. If compressed air is introduced from the port 55 and guided to the front chamber 54, then discharged from the port 57, the piston 52 is lowered. If compressed air is introduced from the port 57 and guided to the rear chamber 56, then discharged from the port 55, the piston 52 is raised. A center pin 50 is provided on a lower end of the piston 52, and extends downwards inside the axial hole 43. The center pin 50 can be lowered to just slightly past the bottom surface 84 of the center hole 82 by the piston 52. An O-ring for making the inside of the piston 52 airtight is provided on the lower end of the piston 52. Because sliding resistance does not actually act on the turbine 44, the turbine 44 will continue to rotate under inertia even if supply of compressed air from the introduction port 47 is stopped. If the piston 52 is pushed down, the O-ring is brought into pressed contact with a tapered upper end of the spindle 42, and the spindle 42 is stopped. The piston 52 thus acts as a brake for stopping rotation of the spindle 42. The piston 52 has an axial hole 53 communicating with the axial hole 43 of the spindle 42. A suction unit 40 capable of suctioning and blowing air is provided at an upper end of the piston 52. As shown in FIG. 4, when the piston 52 is brought into press contact with the spindle 42, the axial holes 43 and 53 are made airtight.

As shown in FIG. 1, the machine tool is provided with a cleaning unit 9 at a position separated from the workpiece. The cleaning unit 9 sprays volatile cleaning fluid onto the shrink fit holder 8 or the tool 70. When the shrink fit holder 8 is cleaned, the shrink fit holder 8 or the tool 70 are moved by the spindle head 2 to be positioned inside the cleaning unit 9. Cleaning fluid is sprayed with the shrink fit holder 8 or the tool 70 being rotated at a specified rotational speed. As the shrink fit holder 8 is heated to a high temperature of about 500° C., there is a potential problem of swarf and oil content becoming firmly attached to the shrink fit holder 8 and it being impossible to insert the tool 70. Therefore, by cleaning the tool 70 and the shrink fit holder 8 after use, it is possible to avoid a situation where automatic tool changing must be aborted. It is also possible to further prolong the life span of the shrink fit holder 8.

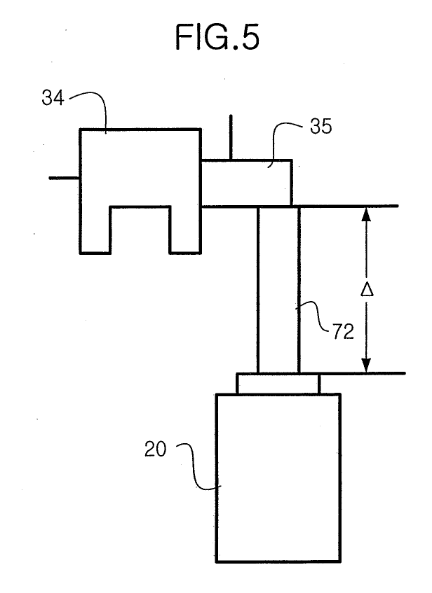

A tool changing process for the machine tool of the present invention will now be described in detail. The damper 34 extracts a new tool 70 from the tool magazine 32, and moves the new tool 70 to a retracted position of the supply pot 20. The supply pot 20 receives a new tool 70 from the damper 34. As shown in FIG. 5, the supply pot 20 holds the tool 70 so that the shank 72 projects upwards by a projection length Δ. A measurement unit for measuring the projection length Δ is provided. The measurement unit includes a stopper 35 provided on a side surface of the damper 34, and a contact detector (not shown) for detecting contact between the stopper 35 and the tool 70. The stopper 35 is positioned at the same height as the lower end of the shrink fit holder 8. The shank 72 is raised up by the Z axis carriage 26 until it contacts the stopper 35. At the time contact between the shank 72 and the stopper 35 is detected, the position of the Z axis carriage 26 is detected, and the projection length Δ is obtained based on the detected position. The size of the shanks 72 will vary in up to a millimeter order. By measuring the projection length Δ, it is possible to position the new tool 70 closely to the shrink fit holder 8 without the new tool 70 colliding.

Machining is stopped in accordance with a specified control sequence, and rotation of the spindle 42 is stopped by the piston 52. The piston 52 is pushed down to lower the center pin 50. A shutter 29 for isolating the retracted positions from the spindle head 2 and the workpiece is opened. The supply pot 20, collection pot 21, high frequency induction heating unit 10 and cooling unit 14 are moved to the shrink fit holder 8. The ring 12 is positioned so as to surround the shrink fit holder 8. The collection pot 21 is positioned so that a cutting blade of a used tool 70 is placed into the collection pot 21. The shrink fit holder 8, ring 12 and collection pot 21 are aligned vertically. The high frequency induction heating unit 10 heats the shrink fit holder 8 using high frequency induction, and the suction unit 40 blasts air into the center hole 82. A used tool 70 is dropped into the collection pot 21 by expansion of the center hole 82. The collection pot 21 is lowered by the Z axis carriage 26. The supply pot 20 is moved by the V axis carriage 28 and the Z axis carriage 26 and is vertically aligned with the shrink fit holder 8. At this time, the supply pot 20 is positioned based on a measurement value for the projection length Δ so that a gap between the new tool 70 and the shrink fit holder 8 becomes a set value. The set value is 0.1-0.2 mm. If the suction unit 40 suctions air from the axial holes 43 and 53, the shank 72 is drawn into the expanded center hole 82. At the same time as or immediately after operation of the suction unit 40, the supply pot 20 is lowered by the Z axis carriage 26. As shown in FIG. 4, a top surface 74 of the shank 72 is in point contact with the center pin 50, inside the center hole 82. The center pin 50 can make the length L, by which the tool 70 projects downward from the shrink fit holder 8, constant. If the end surface 74 of the shank 72 and the bottom surface 84 of the center hole 82 come into surface contact, the tool 70 is likely to be tilted. The center pin 50 can locate the tool 70 vertically in the center hole 82.

The cooling unit 14 blows compressed air to the shrink fit holder 8 until the shrink fit holder 8 and the tool 70 are tightly bound. The shrink fit holder 8 is locally heated so there is no need for excessively cooling. The cooling unit 14 can be capable of blowing normal temperature compressed air. After stopping the cooling unit 14, the high frequency induction heating unit 10 is lowered by the Z axis carriage 16 until the ring 12 is taken away from the shrink fit holder 8. The high frequency induction heating unit 10 is further returned to its retracted position by the V axis carriage 18. The collection pot 21 is also returned to its retracted position. The shutter 29 is then closed. The damper 34 is moved to the retracted position of the collection pot 21. The damper 34 extracts a used tool 70 from the collection pot 21, and is moved to the tool magazine 32. The used tool 70 is returned to an empty position in the tool magazine 32. The piston 52 is then raised up so that the spindle 42 can rotate. The above-described process is typically carried out in a few tens of seconds.

The embodiments have been chosen in order to explain the principles of the invention and its practical applications, and many modifications are possible in light of the above teaching. It is intended that the scope of the invention be defined by the claims appended hereto.

1. A machine tool comprising:
a rotatable spindle;
a shrink fit holder fixed to a lower end of the spindle, the shrink fit holder being configured to hold a tool; and
a high frequency induction heating unit configured to heat the shrink fit holder by high frequency induction;
wherein the high frequency induction heating unit is configured to move between the shrink fit holder and a retracted position separated from the shrink fit holder.

2. The machine tool of claim 1, further comprising a Z axis carriage configured to move the high frequency induction heating unit vertically, and a V axis carriage configured to move the high frequency induction heating unit horizontally.

3. The machine tool of claim 1, wherein the high frequency induction heating unit includes a heating coil, and a high frequency power supply configured to supply high frequency power to the heating coil.

4. The machine tool of claim 3, wherein the heating coil has a ring configured to surround the shrink fit holder.

5. The machine tool of claim 1, further comprising a cooling unit provided on the high frequency induction heating unit, the cooling unit being configured to cool the shrink fit holder.

6. The machine tool of claim 5, wherein the cooling unit supplies compressed air to the shrink fit holder.

7. A machine tool comprising:
a rotatable spindle;
a shrink fit holder fixed to a lower end of the spindle, the shrink fit holder being configured to hold a tool; and
a pair of pots provided side by side configured to respectively hold a tool;
wherein the pair of pots are configured to move between the shrink fit holder and a retracted position separated from the shrink fit holder.

8. The machine tool of claim 7, further comprising a Z axis carriage configured to move the pair of pots vertically, and a V axis carriage configured to move the pair of pots horizontally.

9. The machine tool of claim 7, further comprising a tool magazine configured to store tools and a damper configured to grasp a tool, wherein the damper is configured to move between the tool magazine and the retracted position.

10. The machine tool of claim 9, further comprising a raising and lowering unit configured to move the damper vertically, and a U axis carriage configured to move the damper horizontally.

11. The machine tool of claim 7, further comprising a high frequency induction heating unit configured to heat the shrink fit holder by high frequency induction.

12. A machine tool comprising:
a rotatable spindle;
a shrink fit holder, having a central hole into which a tool can be inserted from below, fixed to a lower end of the spindle;
a supply pot configured to hold the tool so as to project upward by a projection length; and
a measuring unit configured to measure the projection length;
wherein the supply pot can move between the shrink fit holder and a retracted position separated from the shrink fit holder.

13. A machine tool comprising:
a rotatable spindle having an axial hole passing therethrough;
a shrink fit holder, having a central hole for insertion of a tool, fixed to a lower end of the spindle, the central hole communicating with the axial hole; and
a suction unit configured to suction air inside the axial hole.

14. The machine tool of claim 13, wherein the suction unit is configured to discharge air into the axial hole.

15. The machine tool of claim 13, further comprising a center pin configured to lower inside the central hole through the axial hole.

16. The machine tool of claim 15, further comprising a piston configured to reciprocate vertically, the piston comprising a lower end to which the center pin is attached.
